(19) United States
(12) Patent Application Publication
(10) Pub. No.: US 2008/0172835 A1
(43) Pub. Date: Jul. 24, 2008

(54) Hinge assembly with multiple resilient spacers

(76) Inventor: Chun-Ching Hsu, Shulin City (TW)

Correspondence Address: Hershkovitz & Associates, LLC, 2845 Duke Street, Alexandria, VA, 22314, US

(21) Appl. No.: 11/655,224

(22) Filed: Jan. 19, 2007

(51) Int. Cl. E05F 1/12

(52) U.S. Cl. 16/305

(57) ABSTRACT

A hinge with multiple resilient spacers has a body, a rotating element, multiple bolt assemblies and multiple resilient spacers. Both of the body and the rotating element have corresponding through holes. The bolt assemblies are mounted through the through holes of the body and the rotating element. The resilient spacers are mounted on the bolt between the body and the rotating element. Each resilient spacer has at least one surface selectively abutting the body and the rotating element. Each surface of the resilient spacer has multiple concentric grooves formed in the surface. With such an arrangement, the surfaces of the resilient spacers partially abut the body or the rotating element. Therefore the rubbing area of the resilient spacers are reduced. Such that greasing may be unnecessary and abrasion or noise may effectively prevented.

### BACKGROUND OF THE INVENTION

1. Field of the Invention

The present invention relates to a hinge, and more particularly to a hinge with multiple resilient spacers that effectively prevent abrasion occurring or noise generated.

2. Description of Related Art

Hinges are widely used in various devices in people's life. A conventional hinge comprises a body and a rotating element. The body and the rotating element respectively have corresponding through holes, such that multiple bolts are mounted in the through holes of the body and the rotating element to allow the rotating element to rotate relative to the body.

To keep the body or the rotating element from abrasion, multiple spacers are mounted on the bolt between the body and the rotating element. The spacers are normally metallic and have two surfaces abutting respectively to the body and the rotating element to keep the body separated from the rotating element and to prevent attrition.

However, the spacers have to be greased all the time that ensure spacers are slidable between the body and the rotating element. If the spacers are mounted without greasing, abrasion may occur and noise may be generated.

To overcome the shortcomings, the present invention provides a hinge with resilient spacer to obviate or mitigate the aforementioned problems.

### SUMMARY OF THE INVENTION

The main objective of the present invention is to provide a hinge with resilient spacer that resolves the problems of the conventional hinges.

To achieve the objective, the hinge with resilient spacer in accordance with the present invention comprises a body, a rotating element, multiple bolt assemblies and multiple resilient spacers. Both of the body and the rotating element have a surface and corresponding through holes. The bolt assemblies are mounted through the through holes of the body and the rotating element. The resilient spacers may be made of plastic or plastic steel, are mounted on the bolt assemblies adjacent to the body or the rotating element. Each resilient spacer has at least one surface selectively abutting the body and the rotating element. Each surface of the resilient spacer has multiple concentric grooves formed in the surface, such that the resilient spacers are saw-toothed shaped in cross section.

With such an arrangement, greasing may be unnecessary and abrasion or noise may effectively prevented.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a hinge with resilient spacers in accordance with the present invention;

FIG. 2 is an exploded perspective view of the hinge in FIG. 1;

FIG. 3 is a perspective view of a resilient spacer of the hinge in FIG. 1;

FIG. 4 is a top view in partial section of the hinge in FIG. 1; and

FIG. 5 is an exploded perspective view of a second embodiment of a hinge in accordance with the present invention.

### DETAILED DESCRIPTION OF THE PREFERRED EMBODIMENT

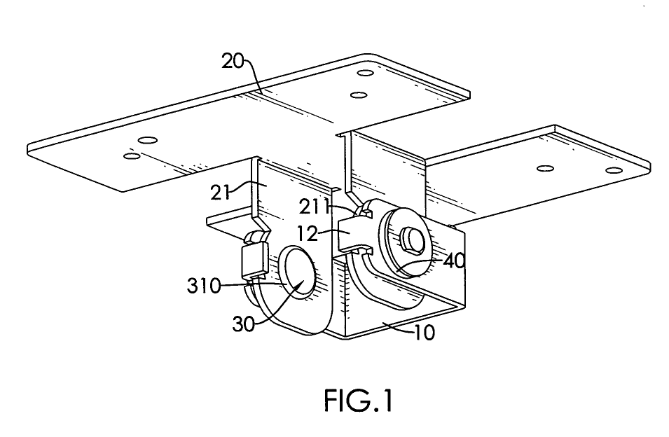

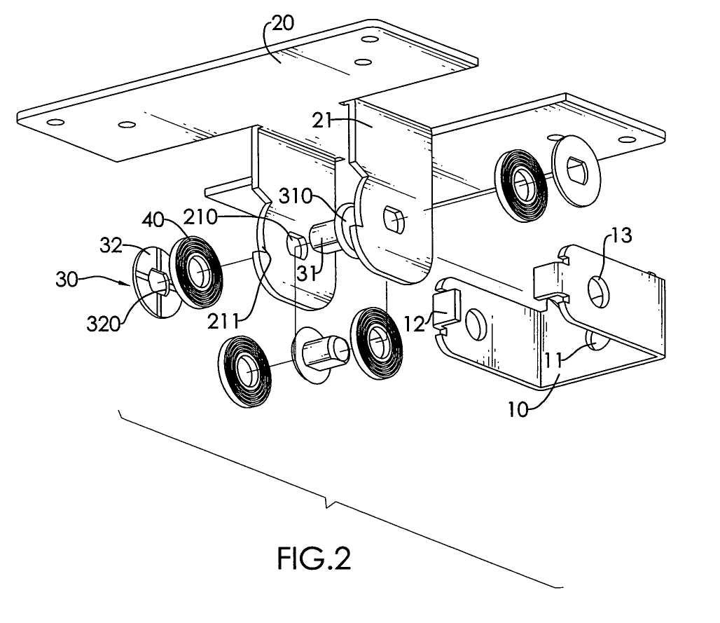

With reference to FIGS. 1 and 2, the hinge with resilient spacer in accordance with the present invention comprises a body (10), a rotating element (20) and multiple resilient spacers (40) and may comprise multiple bolt assemblies (30).

The body (10) is “U” shaped and has a middle, two side wings, two first through holes (13), two optional limits (12) and an optional fixing hole (11). Each side wing has a free end. The first through holes (13) are respectively formed through the side wings near the free ends of the side wings. The limits (12) respectively protrude perpendicularly from the free ends of the side wings. The fixing hole (11) are formed through the middle of the body (10), is extended through by a fastener such as a screw to secure the body (10) onto a plane.

The rotating element (20) is flat and has a front surface, a rear surface and two mounting tabs (21). The front surface is mounted securely with a device (e.g. a penal of a liquid crystal display). The mounting tabs (21) are formed perpendicularly on the rear surface and are parallel to each other. Each mounting tab (21) has an inner side, an outer side, an edge, a distal end, an optional limiting notch (211) and a second through hole (210). The limiting notch (211) is formed in the edge and aligns with and receives the corresponding limit (12) of the body (10) to limit the rotating angle of the rotating element (20). The second through hole (210) is non-circular, is formed through the mounting tab (21) near the distal end of the mounting tab (21) and aligns with the first through holes (13) of the body (10).

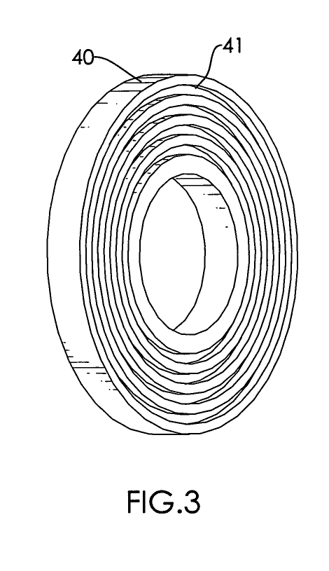

With further reference to FIG. 3, each resilient spacer (40) may be made of plastic or plastic steel and has a central hole and two surfaces. The central hole is formed through the resilient spacer (40) and aligns with the through holes (13, 210) of the body (10) and the rotating element (20). Each surface of the resilient spacer (40) selectively abuts one of the body (10) and the rotating element (20) and has multiple concentric grooves (41) formed in the surface, such that the resilient spacer (40) is saw-tooth shaped in cross section.

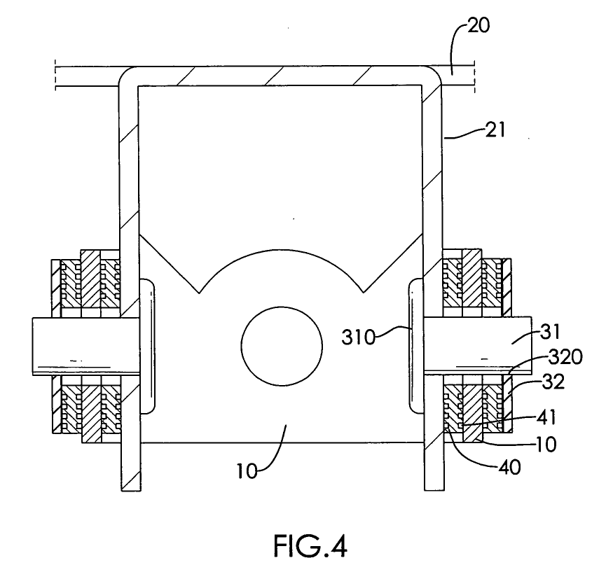

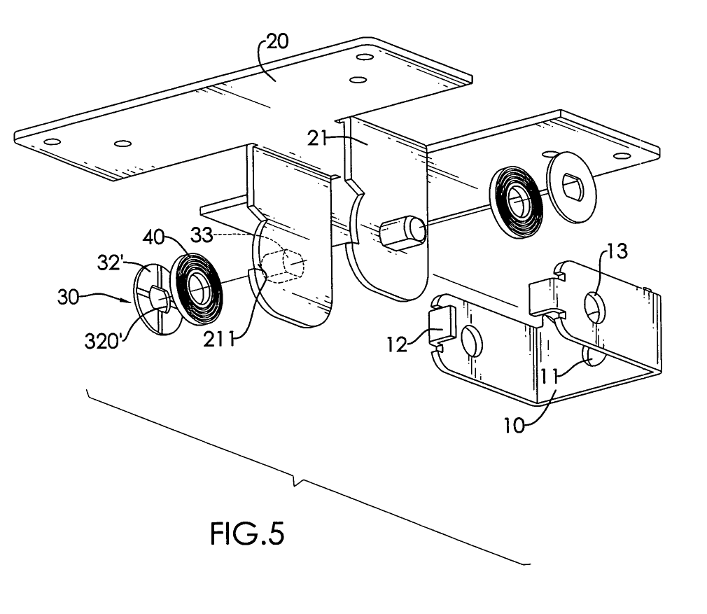

With reference to FIGS. 2, 4 and 5, the hinge as described may have four or two resilient spacers (40). When the hinge as described has four resilient spacers (40) as shown in FIGS. 2 and 4, the resilient spacers (40) are respectively located on the inner sides and the outer sides of the mounting tabs (21). When the hinge as described has two resilient spacers (40) as shown in FIG. 5, the resilient spacers (40) are respectively located on the outer sides of the mounting tabs (21).

Each bolt assembly (30) may have a bolt (31) and a fixing plate (32), or a bolt protrusion (33) and a fixing plate (32).

The bolt (31) has a head (310) and an end, is non-circular in cross section and is mounted through the corresponding central holes of the resilient spacers (40), the corresponding second through hole (210) of the rotating element (20) and the corresponding first through hole (13) of the body (10).

The fixing plate (32) has a non-circular mounting hole (320) mounted securely on the end of the corresponding bolt (31) by riveting or welding to hold at least one resilient spacer (40) securely and tightly in position.

With reference to FIG. 5, the bolt protrusion (33) has an end, is non-circular in cross section and is formed integrally on one of the mounting tabs (21) near the distal end of the mounting tab (21). The bolt protrusion (33) is mounted through the corresponding central hole of at least one resilient spacer (40) and the corresponding first through hole (13) of the body (10).

The fixing plate (32′) has a non-circular mounting hole (320′) mounted securely on the end of the corresponding bolt protrusion (33) by riveting or welding to hold the at least one resilient spacer (40) securely and tightly in position.

With such an arrangement, the resilient spacers (40) are mounted between the body (10) and the rotating element (20) and simultaneously rotates with the rotating element (20). By the formation of the concentric grooves (41), vibrations generated during the rotating element (20) rotating is effectively absorbed by the resilient spacers (40). Moreover, the resilient spacers (40) are operating with high flexibility that keep the resilient spacers (40) from attriting the surfaces of the body (10) and the rotating element (20). Accordingly, abrasion or noise is effectively prevented.

Otherwise, the resilient spacers (40) are tightly mounted between the body (10) and the rotating element (20) via slightly deformation, so that rotation of the rotating element (20) may be more stable.

Even though numerous characteristics and advantages of the present invention have been set forth in the foregoing description together with details of the structure and function of the invention, the disclosure is illustrative only. Changes may be made in detail especially in matters of shape, size and arrangement of parts within the principles of the invention to the full extent indicated by the broad general meaning of the terms in which the appended claims are expressed.

What is claimed is:

1. A hinge with resilient spacer comprising
a body;
a rotating element mounted rotatably to the body; and
at least one resilient spacer mounted respectively adjacent to the body and the rotating element, each resilient spacer having at least one surface selectively abutting the body and the rotating element, and each surface of each resilient spacer having multiple concentric grooves formed in the surface.

2. The hinge with resilient spacer as claimed in claim 1, wherein
the body has
a middle;
two side wings, and each side wing having a free end; and
two first through holes being respectively formed through the side wings near the free ends of the side wings;
the rotating element has
a rear surface; and
two mounting tabs formed perpendicularly on the rear surface and being parallel to each other, and each mounting tab having
an inner side;
an outer side;
an edge;
a distal end; and
a second through hole being formed through the mounting tab near the distal end of the mounting tab and aligning with the first through holes of the body;
each resilient spacer further has a central hole being formed through the resilient spacer and aligning with the first through holes of the body and the second through holes of the rotating element; and
the hinge in accordance with the present invention further has multiple bolt assemblies, each bolt assembly having
a bolt having a head and an end and being mounted through the central hole of a corresponding resilient spacer, a corresponding second through hole of the rotating element and a corresponding first through holes of the body; and
a fixing plate being mounted securely on the end of the bolt.

3. The hinge with resilient spacer as claimed in claim 1, wherein
the body has
a middle;
two side wings, and each side wing having a free end; and
two first through holes being respectively formed through the side wings near the free ends of the side wings;
the rotating element has
a rear surface; and
two mounting tabs formed perpendicularly on the rear surface and being parallel to each other, and each mounting tab having
an inner side;
an outer side;
an edge;
a distal end; and
a second through hole being formed through the mounting tab near the distal end of the mounting tab and aligning with the first through holes of the body;
each resilient spacer further has a central hole being formed through the resilient spacer and aligning with the first through holes of the body and the second through holes of the rotating element; and
the hinge in accordance with the present invention further has multiple bolt assemblies, each bolt assembly having
a bolt protrusion having an end, being formed integrally on one of the mounting tabs near the distal end of the mounting tab and being mounted through the corresponding central hole of at least one resilient spacer and a corresponding first through hole of the body;
a fixing plate being mounted securely on the end of the bolt protrusion.

4. The hinge with resilient spacer as claimed in claim 2, wherein
the body further has
two limits respectively protruding perpendicularly from the free ends of the side wings; and
each mounting tab of the rotating element further has
a limiting notch being formed in the edge and corresponding to and receiving a corresponding limit of the body.

5. The hinge with resilient spacer as claimed in claim 3, wherein
the body further has
two limits respectively protruding perpendicularly from the free ends of the side wings; and
each mounting tab of the rotating element further has
a limiting notch being formed in the edge and corresponding to and receiving a corresponding limit of the body.

6. The hinge with resilient spacer as claimed in claim 4, wherein
the bolt is non-circular in cross section;
each second through hole of the rotating element is non-circular; and
the fixing plate further has a non-circular mounting hole mounted securely on the end of the corresponding bolt.

7. The hinge with resilient spacer as claimed in claim 5, wherein
the bolt protrusion is non-circular in cross section; and
the fixing plate further has a non-circular mounting hole mounted securely on the end of the corresponding bolt protrusion.
